(19) United States
(12) Patent Application Publication
(10) Pub. No.: US 2022/0058726 A1
(43) Pub. Date: Feb. 24, 2022

(54) NETWORK BASED REAL TIME PAYMENT ROUTING

(71) Applicant: Wells Fargo Bank, N.A., San Francisco, CA (US)

(72) Inventors: Christopher Robert Miller, Brooklin (CA); Lauren Gray Bergsland, Plymouth, MN (US); Kristin K. Koppelman, Bloomington, MN (US); Sridhar Uppaluri, Minneapolis, MN (US); Jeremy Craig Rose, Gresham, OR (US)

(21) Appl. No.: 15/391,658

(22) Filed: Dec. 27, 2016

(51) Int. Cl. G06Q 30/08; G06Q 20/10; G06Q 40/02

(52) U.S. Cl. CPC G06Q 30/08; G06Q 40/02; G06Q 20/102

(57) ABSTRACT

Disclosed in some examples are methods, systems, and machine readable mediums for online competitive payment bidding and route selection. A payment route matching and selection service may be a network accessible computer based service which allows banks to submit payment requests that are bid on by banks that wish to handle the payment, or part of the payment. Payment requests may specify one or more desired payment properties (such as cost, speed, and the like). Bids may specify offered payment properties (e.g., cost, speed, and the like). The payment route matching and selection service may then attempt to find a payment route (including zero or more payment legs) that most closely (relative to the other routes) matches the desired payment properties of the payment request based upon the offered payment properties of the submitted bids.

### TECHNICAL FIELD

Embodiments pertain to computer based interbank payment processing. Some embodiments relate to automated bidding marketplaces for interbank payment processing.

### BACKGROUND

Payments between two parties are typically conducted between a source bank and a destination bank and may involve one or more intermediate banks. Payments are transferred as a series of digital messages over one or more networks (such as the Internet) along with a payment settlement at a later time.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flow diagram of a payment marketplace system according to some examples of the present disclosure.

FIG. 2 is a flowchart of a method of a bank computing system participating in the payment marketplace according to some examples of the present disclosure.

FIG. 3 shows a flowchart of a method of bidding on a payment request according to some examples of the present disclosure.

FIG. 4 shows a flowchart of a method of a route matching and selection service matching a payment request to bids to determine payment routes according to some examples of the present disclosure.

FIG. 5. shows an example of a graph constructed by the route matching and selection service according to some examples of the present disclosure.

FIG. 6 shows a logical block diagram of an example bank computing system and route matching and selection service computer system according to some examples of the present disclosure.

FIG. 7 is a block diagram illustrating an example of a machine upon which one or more embodiments may be implemented.

### DETAILED DESCRIPTION

Payment cost, settlement details, and other properties of payments made between a source and destination bank are typically determined by agreements negotiated between the two banks ahead of time. This system is inefficient as it requires agreements negotiated in advance and so payment processing cannot react to changing financial conditions. Additionally, there is a problem if a customer of the source bank wants to send money to a beneficiary at a destination bank that doesn't have an agreement with the source bank. The traditional way of solving the latter problem is by using intermediate banks and sending the payment via one or more payment legs. For example, if a payment originates at bank A and is to a beneficiary at bank C, where A and C do not have an agreement, bank A may determine a third bank that has an agreement with both bank A and bank C (e.g., bank B). The payment is then routed from A to B to C. This solution is both slow (as it requires time to calculate) and inefficient as it may result in suboptimal payment routing that routes payments by slower or more expensive routes because of these static agreements.

Disclosed in some examples are methods, systems, and machine readable mediums for online competitive payment bidding and route selection. A payment route matching and selection service may be a network accessible computer based service which allows banks to submit payment requests that are bid on by banks that wish to handle the payment, or part of the payment. Payment requests may specify one or more desired payment properties (such as cost, speed, and the like). Bids may specify offered payment properties (e.g., cost, speed, and the like). The payment route matching and selection service may then attempt to find a payment route (including zero or more payment legs) that most closely matches the desired payment properties of the payment request based upon the offered payment properties of the submitted bids. The determined payment route may have one or more payment legs—thus when finding a payment route that most closely matches the desired payment properties, the route matching and selection service may factor in the offered payment properties of all payment legs. For example, if the desired payment property of the payment is to select the lowest cost payment, the system may find the payment route with the lowest cost aggregated across all payment legs.

The disclosed systems, methods, and machine readable mediums thus provide improvements to conventional bank payment processing by utilizing improvements to computer systems to create a network based real-time or near-real time online payment bidding system. This system provides more flexible payment processing that automatically calculates the optimal payment route based upon the customer's needs and priorities. Furthermore, this system also allows banks to flexibly tailor (and quickly change if need be) payment terms and conditions based upon rapidly changing market conditions rather than being stuck in long term, pre-negotiated deals.

Bids are offers to handle at least a portion of a payment route (e.g., a payment leg) between a source bank and a destination bank with certain offered payment properties. Example offered payment properties include cost, speed, settlement details, payment type, currencies handled (and exchange rates), and the like. Payment requests are requests to transfer money between a source bank (including a payor) and a destination bank (including a beneficiary) and may include one or more source and destination account numbers, one or more desired payment properties, and the like. Example desired payment properties may include cost, speed, settlement details, payment type, currencies handled (and exchange rates), and the like. The desired payment properties may be specified for the entire payment from source to destination, whereas the offered payment properties may be for one or more portions (e.g., legs) of a payment route.

Bids may be dynamic in that banks may submit bids through their computer systems in response to each payment (e.g., based upon business logic rules on their computer systems or based upon a human determined bid). For example, in response to one or more notifications received from the payment route matching and selection service sent when the payment route matching and selection service receives a payment request. In other examples, the banks may store rules with the payment route matching and selection service. These configurable rules may be utilized by the payment route matching and selection service to automatically create bids in response to a specific payment. Rules may include which banks the bank will route payments to, when those payments can be routed, settlement details, cost, size of payments, currencies, and the like. Rules may be in the form of if-then statements which may output a bid in the form of one or more payment properties. For example: If payment is to bank B, and amount <$5,000, then cost is $X, settlement terms are Y, and time is Z; where X, Y, and Z are placeholders for actual values and terms.

The payment route matching and selection service may utilize the bids to determine one or more payment routes and return them (along with bid information) back to the source bank. The source bank may then select a desired payment route and then process the payment using that route (with or without assistance from the payment route matching and selection service). The routes returned may include one or more payment legs. That is, the route returned may include one or more intermediate banks between the source and destination banks.

In some examples, to select a route, the payment route matching and selection service may construct a graph data structure where banks are nodes. Edges connecting each node are created based upon data entered by banks upon registering with the payment route matching and selection service and indicate an ability to make a payment from the source node to the destination node. When handling a payment request, edge weights may be assigned based upon current bids and may correspond to one or more of the offered payment properties (or a numerical approximation) in the bid for the leg corresponding to the edge. The payment route matching and selection service may then employ pathfinding algorithms on the graph data structure to determine one or more paths from the source node (source bank) to the destination node (destination bank) that satisfy or best meet the constraints indicated in the desired payment properties of the payment request. Example pathfinding algorithms include Dijkstra's algorithm, the A* algorithm, D* algorithm, and the like.

As an example, payment cost may be used as the distance metric and edge weights may reflect the payment cost. The pathfinding algorithm may find the lowest cost payment route by calculating the path with the minimum aggregate of the edge weights for the path. In another example, speed of payment may be used as distance and the algorithm may find the fastest payment route. In some examples, the distance metric may be calculated based upon multiple payment properties. For example two or more of: cost, speed, a settlement details score, currency score, and a payment type score may be inputs to a weighted summation algorithm that produces a distance metric for each edge. The algorithm for calculating the settlement details score may be provided by the source bank and may quantize desirable settlement terms such that higher scores represent more favorable settlement terms for the source bank. Similarly, the payment type score represents a favorability by the source bank for certain payment types (e.g., wire transfers may be worth a certain number of points, whereas other transfer types may be worth more or less points). For currency properties, the exchange rate may be added or subtracted from the total cost associated with a particular leg. The weights for the weighted summation algorithms may be determined by the source bank or the payment route matching and selection service.

In some examples, payment properties in the payment request may be expressed as relative properties, such as “find me the lowest-cost route that can get the payment to the beneficiary in 5 days or less.” In these examples, the payment route matching and selection service may break the problem into a series of steps. For example, the service may first find all paths between the source and destination bank that takes 5 days or less. Then, the service may calculate the route with the lowest cost (e.g., as described above).

As already noted, because a particular bank may only handle (or be able to handle) one leg of the payment, the payment request notifications sent by the payment route matching and selection service may be requests for bids for part of the payment route—e.g., certain payment legs. The payment route matching and selection service may calculate all possible routes between the source and the destination bank based upon the graph constructed based upon the earlier received registration data. The payment route matching and selection service may then send a notification to banks involved in the legs of these possible routes. Upon receiving or determining the various bids, one or more edges of the graph may be updated to reflect cost or other payment properties as already noted.

In some examples, the system may have one or more audit components that allow for the system to monitor bank compliance with their offered payment properties in their bids. This ensures that banks adhere to the payment properties in their bids and that banks can be trusted. In some examples, this may take the form of a bank rating. The bank rating may be used by the source bank when selecting particular routes. In some examples, the bank rating may also be taken into account by the route finding algorithms for example, by increasing or decreasing the cost of a leg depending on the bank ratings involved in that leg. After the payment route is selected and processed, the source bank may rate the banks involved as to how closely they achieved their bids. In some examples, the payment route matching and selection service may monitor the payment for compliance and assign ratings to banks based upon the monitoring. For example, banks may send notifications to the payment route matching and selection service when the payment is processed by the bank.

In some examples, the payment route matching and selection service may also handle payment settlement. For example, the payment route matching and selection service may be run by a large and trusted bank, or government. This payment route matching and selection service would be trusted by participating banks for payment settlement. Source banks would transfer funds to the payment route matching and selection service who would then notify the destination bank that the funds are available. Once the funds are available, the destination bank may then transfer the funds to themselves.

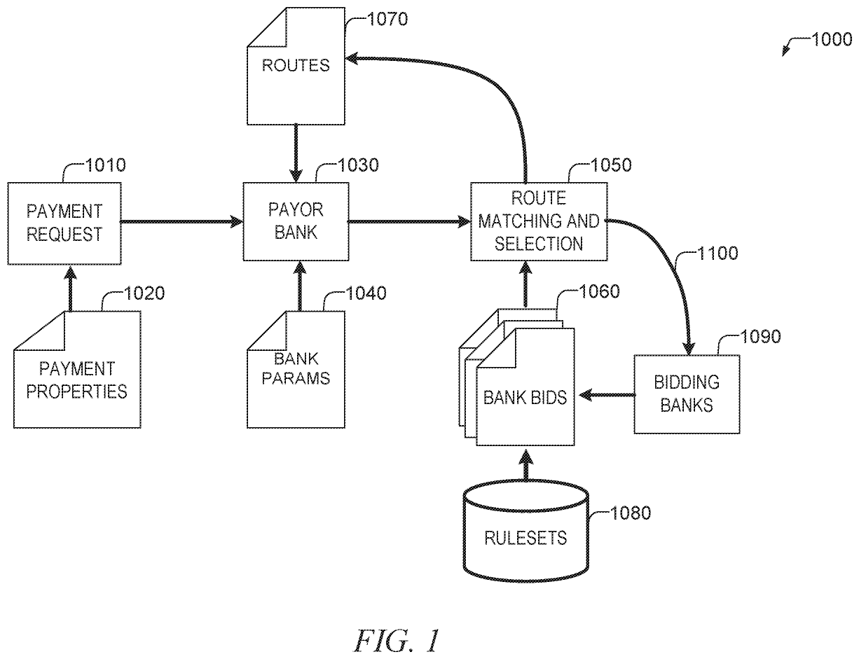

Turning now to FIG. 1 a flow diagram of a payment marketplace system 1000 is shown according to some examples of the present disclosure. A payor submits a payment request 1010 including one or more selectable desired payment properties 1020. The payment request may include a destination bank, a payment beneficiary, a payment amount, and other payment information. The payment request may also include desired payment properties that may include a desired or maximum cost, a desired or maximum timeliness, a desired payment type (e.g., wire, ACH, or the like), and the like. This information is submitted to the payor bank 1030. Payor bank 1030 may provide one or more Graphical User Interfaces (GUI) or customer service representatives to assist users in submitting payment requests. Payor bank 1030 may utilize bank parameters 1040 to determine which payment properties are supported by the bank. These bank parameters 1040 may specify one or more legal values for GUI elements in a GUI or legal values for customer service representatives. Thus, bank parameters 1040 may ensure that payment properties 1020 are legal values supported by the payor bank 1030.

Once the payment request is passed to the payor bank 1030, the payor bank 1030 may confirm that the payment request 1010 complies with the bank parameters 1040 and may then pass (e.g., over a network) the payment request to the route matching and selection service 1050. Route matching and selection service 1050 utilizes bank bids 1060 to determine one or more payment routes 1070 that most closely satisfy the payment properties 1020 of the payment request 1010. As noted previously it may use one or more pathfinding algorithms to find a route from the source bank to the destination bank based upon utilizing one or more of the desired payment properties 1020 in the payment request 1010 and the offered payment properties in the bank bids 1060.

Bank bids 1060 may be submitted by one or more bidding banks 1090. As previously noted, banks may register to be part of the payment marketplace system 1000 with route matching and selection service 1050. As part of this registration process, the bidding banks may submit rulesets 1080, banks that it can route payments to, and the like. As noted, bank bids 1060 may be created on the fly automatically by route matching and selection service 1050 based upon rulesets 1080 submitted previously. In other examples, the bidding banks 1090 will use the rulesets 1080 to automatically create their bank bids 1060 in response to a notification 1100 sent by the route matching and selection service 1050. In still other examples, the bidding banks 1090 may manually determine their bank bids 1060. In yet other examples, one or more of these bid determination methods may be utilized depending on the bank.

Once the payment routes 1070 are determined the route matching and selection service 1050 sends matching routes back to the payor bank 1030. The user, a bank administrator, or a selection module within the banks computer systems (e.g., based upon bank parameters 1040) may select a route. The payor bank 1030 may then send the payment using this route. Payor bank 1030 or route matching and selection service 1050 may notify banks of accepted bids.

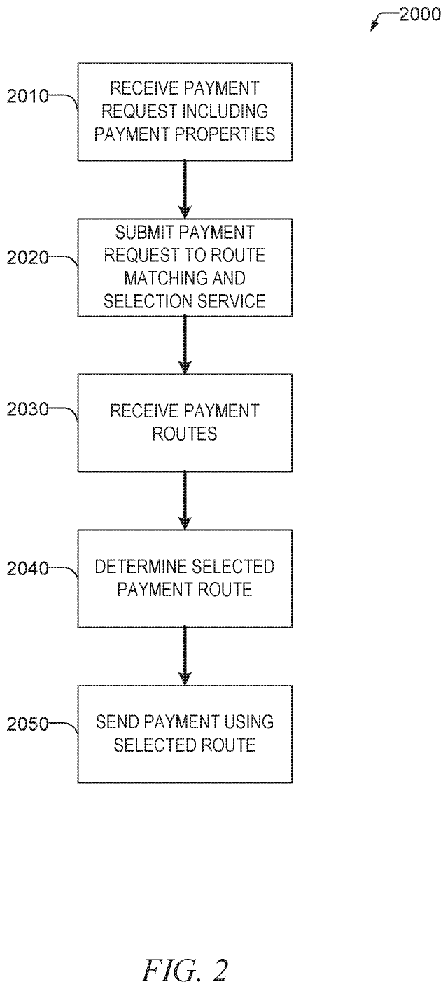

FIG. 2 shows a flowchart of a method 2000 of a bank participating in the payment marketplace according to some examples of the present disclosure. At operation 2010 a computing device of the bank receives a payment request including desired payment properties. This request may be received through a GUI provided to a customer's computer over a network, from a physical bank branch, or the like. The computing device of the bank may verify that the payment properties match business rules of the bank. At operation 2020, the computing device of the bank may submit the payment request to the route matching and selection service. At operation 2030 the route matching and selection service may send, and the bank may receive one or more payment routes. At operation 2040 the bank may determine a selected payment route from the one or more received payment routes. The selected payment route may be selected from the one or more received payment routes by the sender of the payment through one or more GUI interfaces provided by the bank, at a branch location, or the like. In other examples, the bank may automatically select one of the routes (e.g., based upon business rules of the bank). At operation 2050 the bank may send the payment using the selected route. For example, the bank may send the payment electronically by engaging in a communication with a first payment leg in the payment route. The communication may instruct each bank in the route on a next-bank to send the payment to.

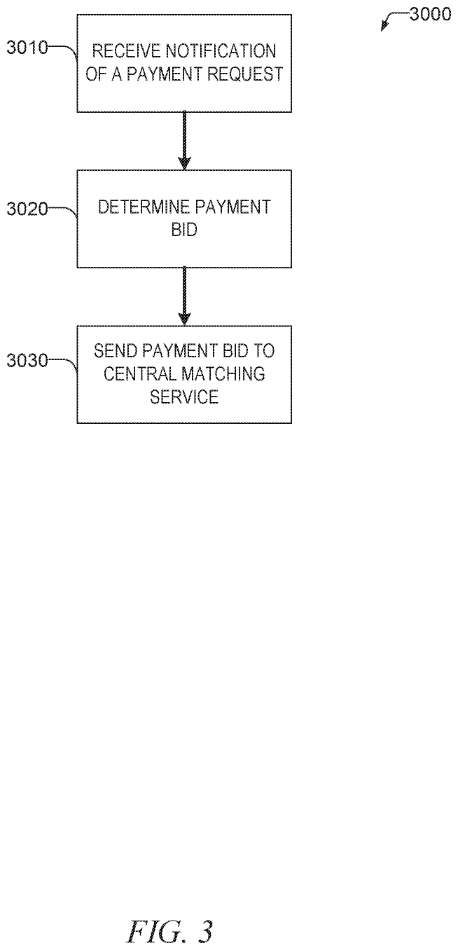

FIG. 3 shows a flowchart of a method 3000 of bidding on a payment request according to some examples of the present disclosure. At operation 3010 a bank computer system may receive a notification of a payment request. For example, the bank may have previously registered to receive notifications from the route matching and selection service of payments whenever a payment request is received. The information provided by the bank upon registration may include one or more electronic network addresses (e.g., Internet Protocol (IP) addresses) with which to send notifications of payment requests. The notification may be sent to the network address provided by the bank during registration.

At operation 3020 the bank may determine a bid. This may be done manually—e.g., an employee of the bank may review the payment request and put together a bid (e.g., through a GU interface provided by the bank and/or the route matching and selection service) or automatically through one or more algorithms that may create a bid based upon one or more predetermined and configurable rulesets. At operation 3030 the bid is sent to the route matching and selection service. As noted previously noted, FIG. 3 is one example way of generating bids. In other examples the route matching and selection service may also determine bids based upon one or more rulesets of the bank.

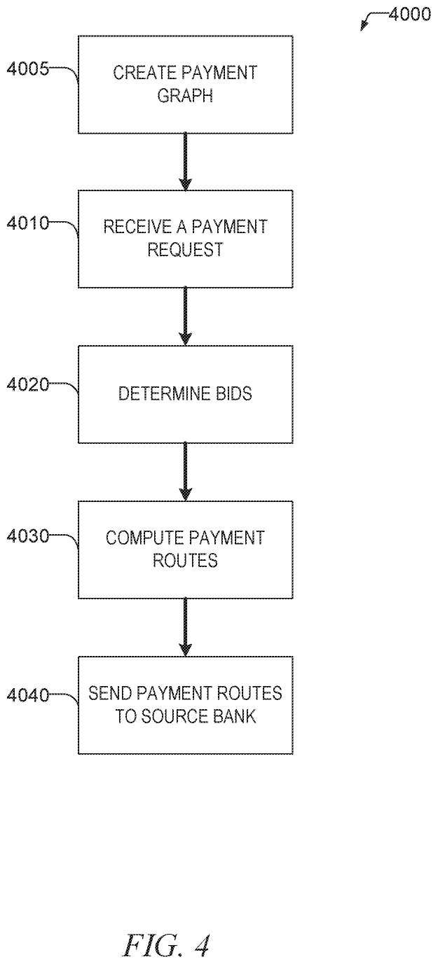

FIG. 4 shows a flowchart of a method 4000 of a route matching and selection service matching a payment request to bids to determine payment routes according to some examples of the present disclosure. At operation 4005, the route matching and selection service may create a payment graph. This graph may be created based upon registration information (or updates to the registration information) submitted by banks. This graph may be maintained and updated as registration information is submitted by banks or updated when changes are made. In other examples, it may be created each time a payment request is received.

At operation 4010 the route matching and selection service receives a payment request including payment parameters. At operation 4020 the route matching and selection service determines one or more bids. This may include electronically notifying computer systems of banks registered to receive notifications of payment requests using their corresponding electronic network addresses, determining bids from stored rulesets for banks, or a combination of both (depending on the preferences of the banks). For example, the route matching and selection service may allow banks to choose whether they want to do on-demand bids or have rulesets stored to generate their bids.

In some examples, as previously discussed, the route matching and selection service may calculate (based upon the graph created) the possible routes between the source and destination. Each bank in the route may be sent a notification or may have a bid calculated depending on their preferences for legs they are involved in. At operation 4030 the optimal payment routes may be computed as previously described. At operation 4040 these payment routes may be sent to the bank that sent the payment request.

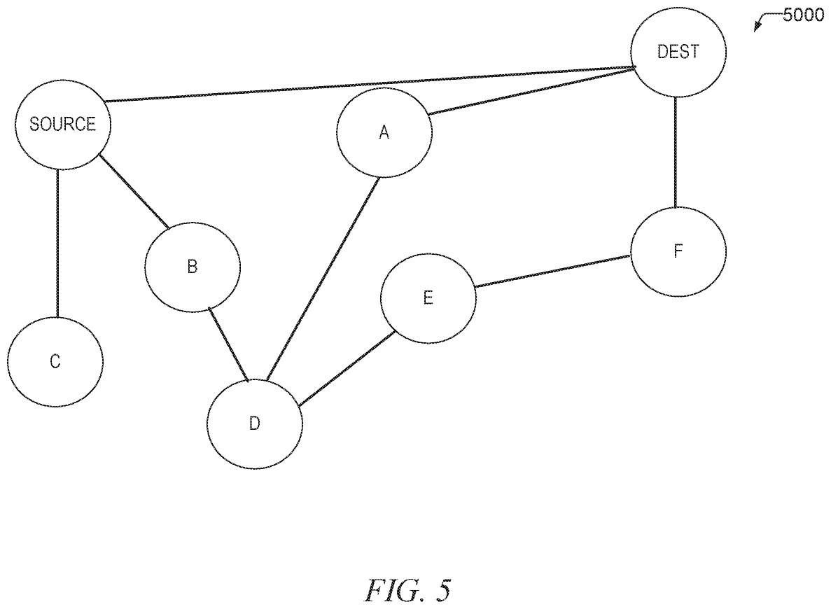

FIG 5. shows an example of a graph 5000 constructed by the route matching and selection service according to some examples of the present disclosure. Each node (source, a, b, c, d, e, f dest) is a bank, each edge represents an ability to send a payment between each bank. A pathfinding algorithm may determine the three routes between the source and destination bank as follows:

Route 1: SOURCE, B, D, A, DEST

Route 2: SOURCE, B, D, E, F, DEST

Route 3: SOURCE, DEST

In the example of FIG. 5, bids may be determined (or notifications for bids) for the SOURCE-B; B-D; D-A; and A-DEST legs of route 1; D-E; F-DEST for route 2 (the SOURCE-B; and B-D were already determined as part of route 1); and SOURCE-DEST legs for route 3. Note that while route 3 is a direct route, it may not be the optimal route as the agreements or bids between the SOURCE and DEST bank may be less than optimal.

A graph, such as shown in FIG. 5 may be stored in memory as a graph database or other structure. As one example, the graph may be stored as a matrix (e.g., a double dimensional array), such as:

| | Source | A | B | C | D | E | F | DEST |
|---|---|---|---|---|---|---|---|---|
| Source | 1 | 0 | 1 | 1 | 0 | 0 | 0 | 1 |
| A | 0 | 1 | 0 | 0 | 1 | 0 | 0 | 1 |
| B | 1 | 0 | 1 | 0 | 1 | 0 | 0 | 0 |
| C | 1 | 0 | 0 | 1 | 0 | 0 | 0 | 0 |
| D | 0 | 1 | 1 | 0 | 1 | 1 | 0 | 0 |
| E | 0 | 0 | 0 | 0 | 1 | 1 | 1 | 0 |
| F | 0 | 0 | 0 | 0 | 0 | 1 | 1 | 1 |
| DEST | 1 | 1 | 0 | 0 | 0 | 0 | 1 | 1 |

Where a ‘1’ represents an edge and a ‘0’ indicates a lack of an edge. In some examples, the ‘1’ may be replaced with the calculated edge weight. Such a graph may be stored as a linked list, a multi-dimensional array, a vector, or the like. In other examples, rather than store the graph in the above mentioned manner, each node may be a data structure with a linked list of other nodes (or node ids) that are connected to that node. In still other examples, more advanced storage may be utilized, such as a graph database.

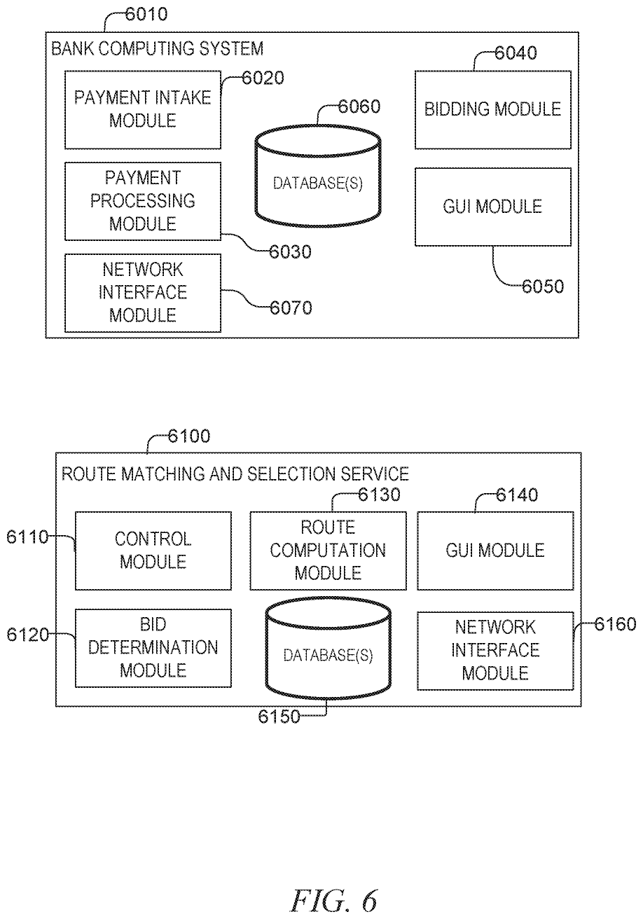

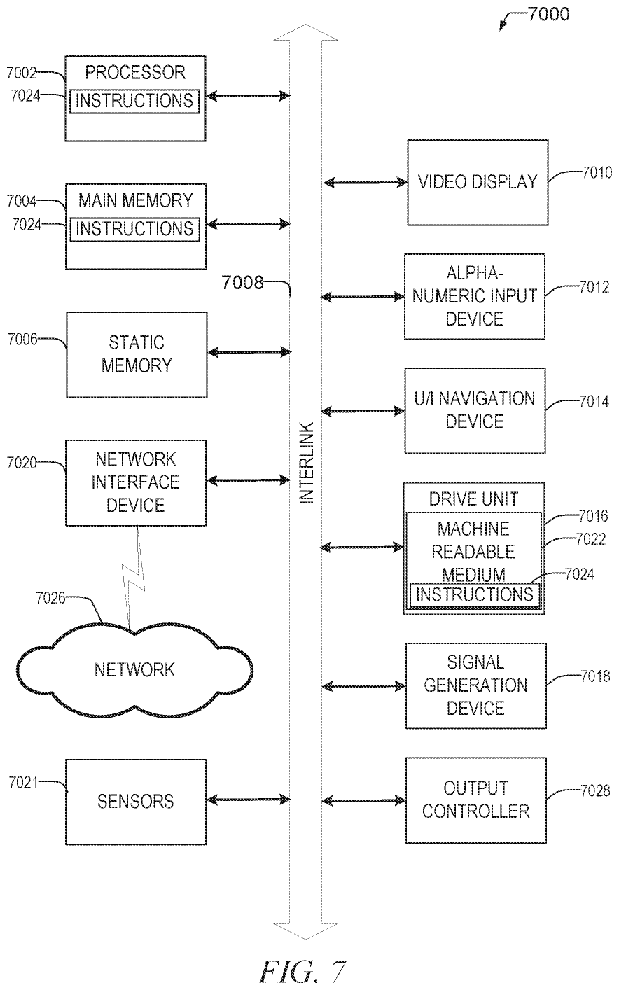

FIG. 6 shows a logical block diagram of an example bank computing system 6010 and route matching and selection service 6100 according to some examples of the present disclosure. While certain example modules are shown in FIG. 6, one of ordinary skill will appreciate that the configuration shown is but one example implementation and that other configurations are contemplated. Additionally, as explained in detail with respect to FIG. 7, a module is a tangible entity that may comprise hardware configured to perform the disclosed functionality through one or more instructions (e.g., software). Modules may communicate with each other through inter-process, intra-process, or network communications using one or more messages formatted according to one or more application programming interfaces (APIs), data structures, function calls, call-backs, procedure calls, objects, and the like.

Bank computing system 6010 may implement the functions of payor bank 1030 and bidding banks 1090 and may include payment intake module 6020, payment processing module 6030, bidding module 6040, GUI module 6050, database 6060, and the like. Payment intake module 6020 may interact with the GUI module 6050 to provide one or more GUI interfaces to allow users to submit payments (e.g., through an online website or to provide a GUI to a teller for in-branch payments, and the like). For example, the GUI module 6050 may be a web server. Payment intake module 6020 may provide one or more fields and legal values of those fields to GUI module 6050 (e.g., based upon the bank parameters, such as bank parameters 1040 of FIG. 1). GUI module 6050 may utilize this information to construct a GUI (e.g., a webpage) that complies with bank payment parameters. Bank payment parameters may specify accepted payment types, dollar amounts, sanction lists (e.g., banks, countries, or beneficiaries to whom a payment is not allowed), settlement requirements, and the like. GUI module 6050 may send GUIs to users and receive selections from users (e.g., customers or bank personnel) using network interface module 6070. Network interface module 6070 may implement one or more network protocol stacks (e.g., Transmission Control Protocol (TCP)/Internet Protocol (IP)) for communicating with one or more computer systems across one or more networks.

GUI module 6050 may receive one or more selections from users among the listed parameters via network interface module 6070. These selections may be communicated to the payment intake module 6020. Payment intake module 6020 may construct a payment request from these selections and may send the payment request to the route matching and selection service (e.g., such as route matching and selection service 6100) via network interface module 6070.

In response, the bank computing system 6010 may receive, via the network interface module 6070, one or more payment route options. Payment intake module 6020 may then present these payment route options to the user (e.g., the payor through their personal computing system or the branch employee through a branch computing system) via the GUI module 6050 and the network interface module 6070. The user may then chose a desired payment route. This selection is received by GUI module 6050 via the network interface module 6070 and forwarded to the payment processing module 6030 along with the payment request and details about the chosen route.

In other examples, the payment intake module 6020 may automatically chose a particular route based upon one or more bank parameters (e.g., which may specify preferred banks or payment types—e.g., routes with more preferred banks or payment types may be chosen). The selected route and the payment request may be forwarded to the payment processing module 6030. The payment processing module 6030 may execute the payment according to established payment methods in accordance with the selected route. For example the payment processing module 6030 may create one or more payment messages (e.g., ACH messages) and send them to banks on the selected route via the network interface module 6070. In some examples, the route information is included in these messages.

In other examples, the selected route may be sent back to the route matching and selection service by the payment intake module 6020 via the network interface module 6070. The route matching and selection service may then inform banks in the selected route. Each payment request may have or be assigned a unique identifier by the route matching and selection service. The payment may then include this unique identifier. This identifier may be used by banks to match their bids with the actual payments as they are received by the banks.

Bidding module 6040 may register with the route matching and selection service 6100 by communicating via the network interface module 6070. During this registration, bidding module 6040 may provide the route matching and selection service 6100 rulesets for determining bids on behalf of bank computing system 6010. Bidding module 6040 may also provide the route matching and selection service 6100 a list of banks that the bank computing system 6010 can route payments to. In other examples, the bidding module 6040 may register to receive notifications of payment requests. Bidding module 6040 may then respond to these notifications with bids. These bids may be generated based upon bank parameters which may include one or more rulesets. The rulesets (either stored in the bank computing system 6010 or with the route matching and selection service 6100) may be configurable by an administrator or other user at the bank through one or more GUIs provided by GUI module 6050 and communicated to the administrator by the network interface module 6070.

GUI module 6050 may provide one or more GUIs. GUIs may be provided by sending to a computing device one or more GUI descriptors. GUI descriptors may include one or more files in one or more formats such as HyperText Markup Language (HTML), eXtensible Markup Language (XML), Content Style Sheets (CSS), JavaScript, scripting language files, plugins, or the like. Additionally GUI descriptors may be data used by one or more dedicated applications running on remote computers that is used to complete or otherwise display a GUI with the application. Database 6060 may store payment requests, payment parameters, bids, payment histories, bank rulesets, bank parameters, and the like.

Route matching and selection service 6100 may be an example implementation of route matching and selection service 1050 of FIG. 1 and may include control module 6110, bid determination module 6120, route computation module 6130, GUI module 6140, database 6150, and network interface module 6160. Control module 6110 receives payment requests via network interface module 6160. Communication with bank computing devices (such as bank computing system 6010) may be conducted according to an application programming interface (API). For example, using a Representational State Transfer (REST) interface.

Payment requests received by the control module 6110 may be passed to the bid determination module 6120. Bid determination module determines one or more bids from financial institutions. In some examples, the bid determination module 6120 may send a notification to one or more banks via network interface module 6160 and may await their response. In some examples, prior to sending the notifications, the bid determination module 6120 may request from the route computation module 6130 the possible paths between the source and destination bank. Bid determination module 6120 may then utilize this information to determine which banks and which legs to request bids from. Bid determination module 6120 may wait a predetermined amount of time for a response. Once the predetermined period of time has elapsed, the bid determination module 6120 assumes all bids are in and the control module 6110 proceeds with the bids it has received. In other examples, bid determination module 6120 may determine bids for one or more banks using bank rulesets submitted by the banks upon registration and stored in the database 6150.

Control module 6110 then passes the payment request and the bid information to the route computation module 6130. Route computation module 6130 may calculate or update a graph data structure based upon the bank registration data and may update edge weights based upon the returned bids. Route computation module 6130 may calculate the edge weights based upon the offered bid properties. As noted, the edge weights may be a single property such as cost, but in other examples it may be a combination of properties. For example, a weighted summation of properties. For example, the edge weights may be: Edge Weight=W1*Cost+W2*SPEED where W1 and W2 are weights.

For payment properties such as settlement terms and payment type that are not numerical, the source bank, the route matching and selection service, or the payment request (as provided by the source bank or the customer) may provide one or more conversion functions to score the offered payment properties so as to convert the offered payment properties of the bids into a numerical score. For example, for payment type, the conversion may be a table that assigns a particular quantity of points for particular payment types.

The weights for the weighted summation may be provided in the payment request as one or more desired payment properties (e.g., the user may specify how important various payment properties are—e.g., cost is more important than speed may indicate cost is weighted more heavily than speed, and the like). Alternatively, the weights may be provided by the source bank or an administrator of the route matching and selection service 6100.

Route computation module 6130 may then compute one or more payment routes that meet (or best meet) the requested payment properties in the payment request. Route computation module 6130 may utilize one or more route finding algorithms as previously discussed. The routes computed may then be returned to the control module 6110. Control module 6110 may then send back one or more of the determined payment routes to the bank computing system that sent the payment request via the network interface module 6160.

GUI module 6140 may provide one or more GUIs. GUIs may be provided by sending to a computing device one or more GUI descriptors. GUI descriptors may include one or more files in one or more formats such as HyperText Markup Language (HTML), eXtensible Markup Language (XML), Content Style Sheets (CSS), JavaScript, scripting language files, plugins, or the like. Additionally GUI descriptors may be data used by one or more dedicated applications running on remote computers that is used to complete or otherwise display a GUI with the application. GUI module 6140 may provide GUIs for submitting payments, registering with the route matching and selection service, selecting a payment route, and otherwise administering the system. Database 6150 may store bank rulesets, bank information (such as which banks can route payments to which other banks), bank payment graphs (as previously described that have banks as nodes with edges representing relationships between banks that allow for a payment between the banks), bids, and the like.

FIG. 7 illustrates a block diagram of an example machine 7000 upon which any one or more of the techniques (e.g., methodologies) discussed herein may perform. In alternative embodiments, the machine 7000 may operate as a standalone device or may be connected (e.g., networked) to other machines. In a. networked deployment, the machine 7000 may operate in the capacity of a server machine, a client machine, or both in server-client network environments. In an example, the machine 7000 may act as a peer machine in peer-to-peer (P2P) (or other distributed) network environment. Machine 7000 may implement in whole or in part, bank computing system 6010, route matching and selection service 6100, the methods of FIGS. 2-5, and the system of FIG. 1. The machine 7000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 7000 may be configured to be a bank computer system, a route matching and selection service 6100, and may be configured to perform the methods of FIGS. 2 and 3. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the tern “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The Machine 7000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISO) techniques. In some examples, the network interface device 7020 may wirelessly communicate using Multiple User MIMO techniques.

1. A payment route matching and selection system, the system comprising:
a processor; and
a memory in communication with the processor, the memory storing instructions, which when executed by the processor, causes the system to perform operations comprising:
creating a payment graph, the payment graph including a plurality of nodes, each node representing a bank, and edges representing payment relationships between banks;
providing a graphical user interface (GUI) to a device of a source bank for use in submitting a payment request, including sending one or more GUI descriptors to the device;
adjusting GUI elements for the GUI based on bank parameters of the source bank to comply with a set of one or more selectable payment properties supported by the source bank using a format provided by the one or more GUI descriptors;
receiving over a network from the source bank the payment request, the payment request specifying the source bank and a destination bank and the set of one or more selectable payment properties;
calculating possible routes between the source bank and the destination bank using the payment graph;
identifying a plurality of banks at nodes along the possible routes;
determining a plurality of bids from the plurality of banks, including automatically creating at least one of the plurality of bids on behalf of at least one of the plurality of banks based upon a previously submitted ruleset from the at least one of the plurality of banks, the ruleset including configurable rules specific to the at least one of the plurality of banks, the bids comprising offers to handle at least a portion of a route from the source bank to the destination bank, the bids including one or more offered payment properties;
electronically monitoring, using one or more audit components, compliance with the one or more payment properties by the plurality of banks;
assigning, using the one or more audit components, a bank rating to each of the plurality of banks using the monitored compliance with the one or more payment properties by the plurality of banks;
assigning weights to the edges based upon the plurality of bids, the bank rating, and the one or more offered payment properties, wherein the assigned weights use a distance metric calculated based on two or more of cost, speed, a settlement details score, a currency score and a payment type score;
computing at least one payment route between the source bank and the destination bank that most closely matches the set of one or more selectable payment properties to the one or more offered payment properties of the plurality of bids using the payment graph, including calculating aggregate edge weights using the assigned weights for the at least one payment route including selecting the at least one payment route having a minimum aggregate edge weight; and
sending the at least one payment route to the source bank.

2. The system of claim 1, wherein the operations comprise:
responsive to receiving the payment request, transmitting information about the payment request to the plurality of banks.

3. The system of claim 1, wherein the configurable rules include one or more of:
an identification of banks the at least one of the plurality of banks will route payments to, when the payments can be routed, settlement details, cost, size of payments, or currencies.

4. The system of claim 1, wherein the operations comprise:
receiving a payment from the source bank destined for the destination bank, the received payment including a payment route from the at least one payment route;
processing the payment according to the payment route;
receiving funds from the source bank; and
providing the funds from the source bank to the destination bank.

5. The system of claim 1, wherein the one or more selectable payment properties comprises a payment speed.

6. The system of claim 1, wherein the one or more selectable payment properties comprises a payment cost.

7. The system of claim 1, wherein one of the one or more offered payment properties comprises an offered payment speed.

8. The system of claim 1, wherein one of the one or more offered payment properties comprises an offered payment cost.

9. A payment route matching and selection method, the method comprising:
using one or more processors:
creating a payment graph, the payment graph including a plurality of nodes, each node representing a bank, and edges representing payment relationships between banks;
providing a graphical user interface (GUI) to a device of a source bank for use in submitting a payment request, including sending one or more GUI descriptors to the device;
adjusting GUI elements for the GUI based on bank parameters of the source bank to comply with a set of one or more selectable payment properties supported by the source bank using a format provided by the one or more GUI descriptors;
receiving over a network from the source bank the payment request, the payment request specifying the source bank and a destination bank and the set of one or more selectable payment properties;
calculating possible routes between the source bank and the destination bank using the payment graph;
identifying a plurality of banks at nodes along the possible routes;
determining a plurality of bids from the plurality of banks, including automatically creating at least one of the plurality of bids on behalf of at least one of the plurality of banks based upon a previously submitted ruleset from the at least one of the plurality of banks, the ruleset including configurable rules specific to the at least one of the plurality of banks, the bids comprising offers to handle at least a portion of a route from the source bank to the destination bank, the bids including one or more offered payment properties;
electronically monitoring, using one or more audit components, compliance with the one or more payment properties by the plurality of banks over a period of time;
assigning, using the one or more audit components, a bank rating to each of the plurality of banks using the monitored compliance with the one or more payment properties by the plurality of banks;
assigning weights to the edges based upon the plurality of bids, the bank rating, and the one or more offered payment properties, wherein the assigned weights use a distance metric calculated based on two or more of cost, speed, a settlement details score, a currency score and a payment type score;
computing at least one payment route between the source bank and the destination bank that most closely matches the set of one or more selectable payment properties to the one or more offered payment properties of the plurality of bids using the payment graph, including calculating aggregate edge weights using the assigned weights for the at least one payment route including selecting the at least one payment route having a minimum aggregate edge weight; and
sending the at least one payment route to the source bank.

10. The method of claim 9, comprising:
responsive to receiving the payment request, transmitting information about the payment request to the plurality of banks.

11. The method of claim 9, wherein the configurable rules include one or more of:
an identification of banks the at least one of the plurality of banks will route payments to, when the payments can be routed, settlement details, cost, size of payments, or currencies.

12. The method of claim 9, comprising:
receiving a payment from the source bank destined for the destination bank, the received payment including a payment route from the at least one payment route;
processing the payment according to the payment route;
receiving funds from the source bank; and
providing the funds from the source bank to the destination bank.

13. The method of claim 9, wherein the one or more selectable payment properties comprises a payment speed.

14. The method of claim 9, wherein the one or more selectable payment properties comprises a payment cost.

15. The method of claim 9, wherein one of the one or more offered payment properties comprises an offered payment speed.

16. The method of claim 9, wherein one of the one or more offered payment properties comprises an offered payment cost.

17. A non-transitory computer-readable medium, comprising instructions stored thereon, which when executed by a computer, causes the computer to perform operations comprising:
creating a payment graph, the payment graph including a plurality of nodes, each node representing a bank, and edges representing payment relationships between banks;
providing a graphical user interface (GUI) to a device of a source bank for use in submitting a payment request, including sending one or more GUI descriptors to the device;
adjusting GUI elements for the GUI based on bank parameters of the source bank to comply with a set of one or more selectable payment properties supported by the source bank using a format provided by the one or more GUI descriptors;
receiving over a network from the source bank the payment request, the payment request specifying the source bank and a destination bank and the set of one or more selectable payment properties;
calculating possible routes between the source bank and the destination bank using the payment graph;
identifying a plurality of banks at nodes along the possible routes;
determining a plurality of bids from the plurality of banks, including automatically creating at least one of the plurality of bids on behalf of at least one of the plurality of banks based upon a previously submitted ruleset from the at least one of the plurality of banks, the ruleset including configurable rules specific to the at least one of the plurality of banks, the bids comprising offers to handle at least a portion of a route from the source bank to the destination bank, the bids including one or more offered payment properties;
electronically monitoring, using one or more audit components, compliance with the one or more payment properties by the plurality of banks;
assigning, using the one or more audit components, a bank rating to each of the plurality of banks using the monitored compliance with the one or more payment properties by the plurality of banks;
assigning weights to the edges based upon the plurality of bids, the bank rating, and the one or more offered payment properties, wherein the assigned weights use a distance metric calculated based on two or more of cost, speed, a settlement details score, a currency score and a payment type score;
computing at least one payment route between the source bank and the destination bank that most closely matches the set of one or more selectable payment properties to the one or more offered payment properties of the plurality of bids using the payment graph, including calculating aggregate edge weights using the assigned weights for the at least one payment route including selecting the at least one payment route having a minimum aggregate edge weight; and
sending the at least one payment route to the source bank.

18. The computer-readable medium of claim 17, wherein the operations comprise:
responsive to receiving the payment request, transmitting information about the payment request to the plurality of banks.

19. The computer-readable medium of claim 17, wherein the configurable rules include one or more of:
an identification of banks the at least one of the plurality of banks will route payments to, when the payments can be routed, settlement details, cost, size of payments, or currencies.

20. The computer-readable medium of claim 17, wherein the operations comprise:
receiving a payment from the source bank destined for the destination bank, the received payment including a payment route from the at least one payment route;
processing the payment according to the payment route;
receiving funds from the source bank; and
providing the funds from the source bank to the destination bank.

21. The computer-readable medium of claim 17, wherein the one or more selectable payment properties comprises a payment speed.

22. The computer-readable medium of claim 17, wherein the one or more selectable payment properties comprises a payment cost.

23. The computer-readable medium of claim 17, wherein one of the one or more offered payment properties comprises an offered payment speed.

24. The computer-readable medium of claim 17, wherein one of the one or more offered payment properties comprises an offered payment cost.
